(19) United States
(12) Patent Application Publication
(10) Pub. No.: US 2014/0258065 A1
(43) Pub. Date: Sep. 11, 2014

(54) COMMODITY CONTRACTS DELIVERY ALLOCATION

(71) Applicant: CHICAGO MERCANTILE EXCHANGE, INC., Chicago, IL (US)

(72) Inventors: Lori Aldinger, Naperville, IL (US); Richard Co, Chicago, IL (US); John Labuszewski, Westmont, IL (US); John Nyhoff, Darien, IL (US)

(73) Assignee: CHICAGO MERCANTILE EXCHANGE, INC., Chicago, IL (US)

(21) Appl. No.: 13/785,709

(22) Filed: Mar. 5, 2013

(51) Int. Cl. G06Q 40/04

(52) U.S. Cl. CPC G06Q 40/04
USPC 705/37

(57) ABSTRACT

For each of in source locations, a number of commodity contract short positions may be determined. Each of the short positions may correspond to an obligation of a short position holder to make delivery of a commodity within a predefined time period, and may further correspond to one of the in source locations. For each of n destination locations, a number of commodity contract long positions may be determined. Each of the long positions may correspond to an obligation of the long position holder to receive delivery of the commodity within the predefined time period, and may further correspond to one of the n destination locations. Short and long positions may be allocated among each of one or more of the source-destination pairs.

### BACKGROUND

Commodity contracts may include commodity futures contracts, which may be multilaterally traded and standardized. Commodity contracts may also include forward contracts, which may be less standardized than futures contracts and be bilaterally traded. A “long” or a “long counterparty” usually refers to a counterparty holding a long position in a commodity contract. A long agrees to pay a contract price in return for the underlying commodity at a predefined future date. A “short” or a “short counterparty” usually refers to a counterparty holding a short position in a commodity contract. A short typically agrees to receive the final settlement price of the contract at the predefined future date in return for delivering the underlying commodity.

There is a long counterparty and a short counterparty associated with each commodity contract. At least with regard to commodity futures contracts, however, either the long or the short of each contract may be an exchange or clearinghouse. For example, a first counterparty may offer to sell a particular type of commodity futures contract through an exchange. After the exchange receives that offer, a second counterparty may submit a bid to the exchange to purchase a commodity futures contract of that same type and at the offered price. The exchange may then match the offer and bid, may establish a first contract in which the first counterparty is the short and the exchange is the long, and may establish a second contract in which the second counterparty is the long and the exchange is the short. The contract price of the first and second contracts (the accepted offer price of the first counterparty) will be the same. The first and second counterparties do not know each other's identities. The long position of the exchange in the first contract offsets the short position of the exchange in the second contract, and thus the exchange does not make or receive delivery. Instead, the exchange will instruct the short of the first contract to make delivery to the long of the second contract (or to a long of another contract of the same type).

Many types of commodity contracts are “physically” settled, i.e., the short counterparty agrees to physically deliver a predefined quantity of the contract commodity at final settlement. Such delivery may occur in any of various manners, e.g., by ship, by rail, by pipeline, by warehouse receipt, etc. The manner of delivery may depend on the nature of the commodity in question and is typically defined by the contract.

A short may potentially supply an underlying commodity from any of numerous source locations. There may also be numerous locations at which a long could take delivery of a commodity. In some instances, source and/or destination locations may be globally dispersed. For example, sugar is produced in Africa, South America, Asia and the United States. A short to a sugar contract might thus potentially supply sugar from a port located in any of those sugar-producing regions. Similarly, a long to a sugar contract may be able to receive delivery in any of many port facilities located throughout the world.

When a commodity contract matures, an exchange or clearinghouse typically matches shorts to longs. In particular, the exchange will provide each short with information indicating where it will make delivery and further indicating a specific long that will be receiving that delivery. The exchange will also provide each long with information indicating where it will receive delivery and further indicating a specific short that will be making that delivery. Conventional delivery matching techniques ignore a short's preferred origin location or a long's preferred destination location. One such technique is to randomly pair shorts with longs. Another such technique is to pair the oldest long with the oldest short, pair the next oldest long with the next oldest short, etc. Conventional delivery matching techniques often yield inefficient and unnecessarily expensive deliveries. Frequently, longs and shorts who have been matched by an exchange will take it upon themselves to swap delivery obligations as a means of cost reduction.

### SUMMARY

This Summary is provided to introduce a selection of concepts in a simplified form that are further described below in the Detailed Description. This Summary is not intended to identify key or essential features of the invention.

In at least some embodiments, a computer system may determine, for each of m source locations, a number commodity contract short positions for which delivery of a commodity will originate from that source location. Each of the short positions may correspond to an obligation of the short position holder to make delivery of the commodity within a predefined time period. The computer system may also determine, for each of n destination locations, a number commodity contract long positions for which delivery of the commodity will be made at that destination location. Each of the long positions may correspond to an obligation of the long position holder to receive delivery of the commodity within the predefined time period. The computer system may then allocate the short and long positions among each of one or more of the source-destination pairs. The allocation may be based at least in part on delivery cost data with an objective of minimizing delivery costs. Based at least in part on the allocation, the computer system may generate assignments of each of the long positions to each of the short positions. The computer system may transmit notifications to holders of the short and long positions indicating the assignments.

Embodiments include, without limitation, methods for allocating commodity contract delivery obligations, computer systems configured to perform such methods, and computer-readable media storing instructions that, when executed, cause a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing trading systems and methods according to at least some embodiments.

FIGS. 2A and 2B are a flow chart showing operations in a process performed by an exchange computer system, in at least some embodiments, to allocate delivery obligations.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, FLASH memory and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as exchange computer system 100 and/or other computers described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

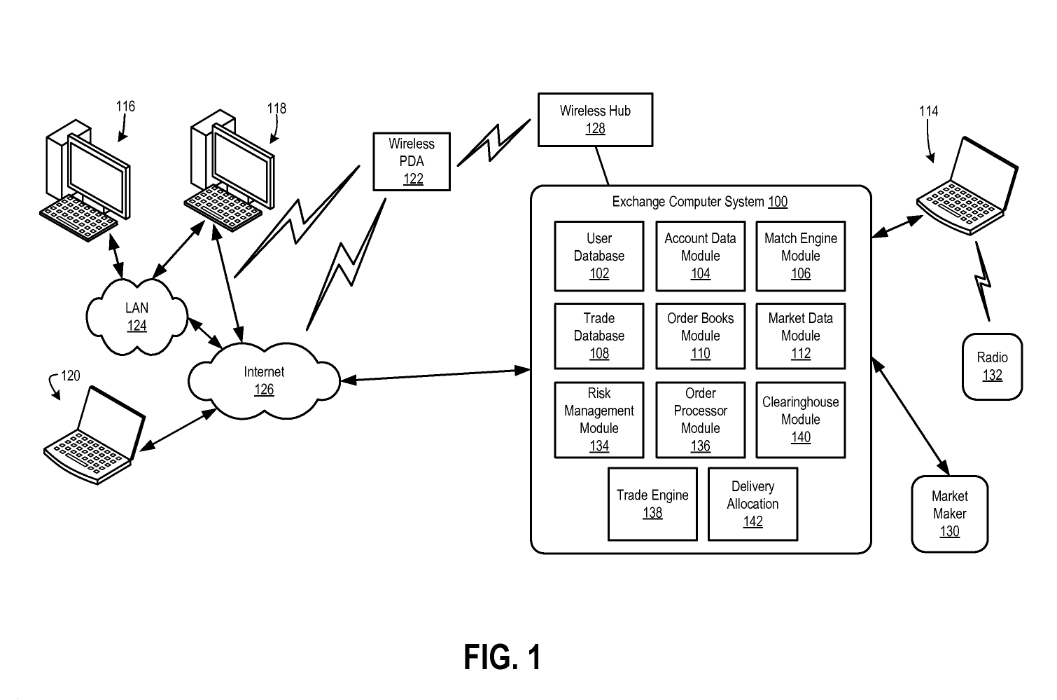

Aspects of at least some embodiments can be implemented with computer systems and computer networks that allow users to communicate trading information. An exemplary trading network environment for implementing trading systems and methods according to at least some embodiments is shown in FIG. 1. The implemented trading systems and methods can include systems and methods, such as are described herein, that facilitate trading and other activities associated with commodity futures contracts and commodities forward contracts.

Computer system 100 can be operated by a financial product exchange and configured to perform operations of the exchange for, e.g., trading and otherwise processing various financial products. Financial products of the exchange may include, without limitation, futures contracts, options on futures contracts, and other types of derivative contracts. Financial products traded or otherwise processed by the exchange may also include over-the-counter (OTC) products such as OTC forwards, OTC options, etc.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out clearinghouse operations. Module 140 may receive data from and/or transmit data to trade database 108 and/or other modules of computer system 100 regarding trades of commodity futures contracts, commodity forward contracts and other financial products. Clearinghouse module 140 may facilitate the financial product exchange acting as one of the parties to every traded contract or other product. For example, computer system 100 may match an offer by party A to sell a commodity futures contract with a bid by party B to purchase a like commodity futures contract. Module 140 may then create a first commodity futures contract between party A and the exchange and a second commodity futures contract between the exchange and party B. As another example, module 140 may maintain margin data with regard to clearing members and/or trading customers. As part of such margin-related operations, module 140 may store and maintain data regarding the values of various contracts and other instruments, determine mark-to-market and final settlement amounts, confirm receipt and/or payment of amounts due from margin accounts, confirm satisfaction of delivery and other final settlement obligations, etc.

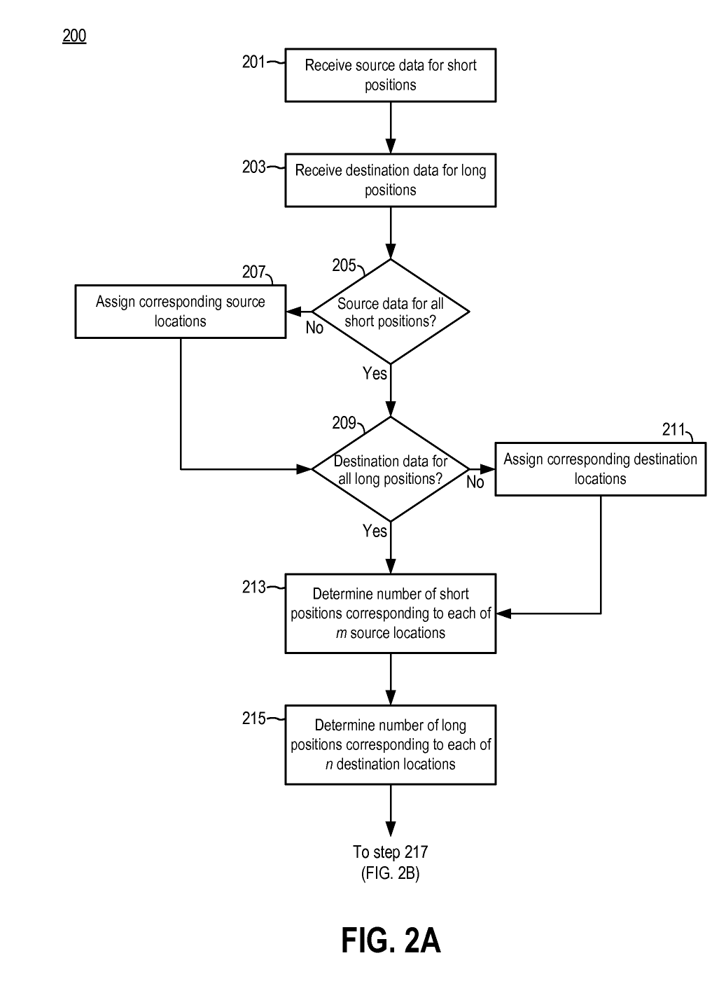

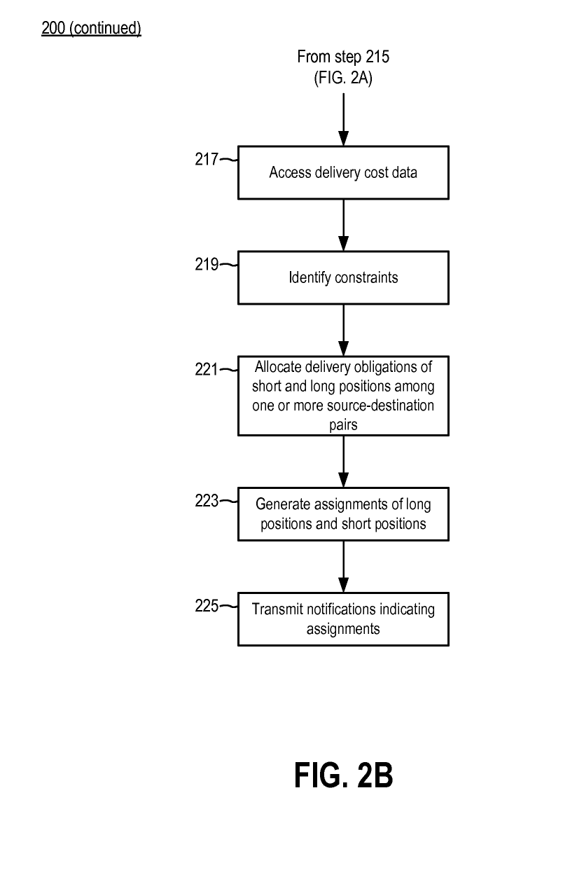

A delivery allocation module 142 may be included as part of exchange computer system 100 and configured to carry out operations associated with allocation of delivery obligations under commodities contracts. Such operations are described below in conjunction with FIGS. 2A and 2B.

Each of modules 102 through 142 could be separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-142).

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems (e.g., computer systems of clearing member firms), regulatory systems and fee systems.

The operations of computer devices and systems shown in FIG. 1 may be controlled by computer-executable instructions stored on non-transitory computer-readable media. For example, computer device 116 may include computer-executable instructions for receiving market data from exchange computer system 100 and displaying that information to a user. As another example, delivery allocation module 142 and/or other modules of exchange computer system 100 may include computer-executable instructions for performing operations associated with allocating delivery obligations associated with commodity contracts.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “system 100”) receives, stores, generates and/or otherwise and processes data so as to allocate delivery obligations associated with commodity contracts. Such contracts can include commodity futures contracts. Commodity futures contracts may be standardized and traded on an exchange, with each contract requiring delivery of a contractually-specified amount of an underlying commodity within a contractually-specified period after contract maturity. Commodities can include, without limitation, agricultural commodities (e.g., corn, wheat, soybeans, soybean meal, soybean oil, palm oil, oats, rice, cattle, hogs, milk, other dairy products, lumber, cocoa, coffee, cotton, sugar, orange juice concentrate), energy commodities (e.g., any of various types of crude oil, natural gas, ethanol, heating oil, gasoline, coal, electricity, uranium), metals and metal products.

Commodity forward contracts are similar to commodity futures contracts and may also require holders of short contract positions to deliver a contractually-specified quantity of a commodity, within contractually-specified periods after contract maturities, to holders of long contract positions. Commodity forward contracts may be less standardized than futures contracts. Moreover, and unlike futures contracts, forward contracts may be bilaterally traded. For example, a short counterparty A and a long counterparty B may negotiate directly with one another and execute a forward contract. However, that forward contract and other similar forward contracts may be cleared and/or otherwise processed by an exchange. In some situations, short A may thus be instructed to deliver the underlying commodity to a long other than long B.

In at least some embodiments, system 100 allocates delivery obligations associated with commodity contracts. For a given type of contract relating to a particular commodity and maturing on a given date, system 100 determines all source locations from which holders of short positions may make delivery. System 100 then determines how many short positions correspond to each of those source locations. System 100 further determines all destination locations at which holders of long positions may take delivery, as well as how many long positions correspond to each of those destination locations. Using data for costs of delivery from each of the source locations to each of the destination locations, system 100 then allocates the delivery obligations of shorts and longs so as to minimize a total cost for deliveries to satisfy the obligations associated with all of the outstanding positions.

FIGS. 2A and 2B are a flow chart showing steps of a method 200, performed by exchange computer system 100 in at least some embodiments, when allocating deliveries associated with commodity contracts. In some embodiments, the steps of method 200 may be performed by delivery allocation module 142 of system 100. In other embodiments, some or all of the steps of method 200 may be performed by other modules of system 100. In still other embodiments, some or all steps of method 200 may be performed by one or more computer systems separate from system 100.

Method 200 is performed with regard to a set of short and long positions in commodity contracts of the same type. Separate instances of method 200 may be performed for each of multiple different types of commodity contracts. All of the commodity contracts at issue in a particular instance of method 200 relate to the same commodity and mature at the same time (or within a relatively short time period). Each holder of a short position in such a contract is obligated to make delivery of a contractually-specified quantity of the commodity within a contractually-specified time period. Each holder of a long position in such a contract is obligated to take delivery of the contractually-specified quantity of the commodity within the contractually-specified time period.

For convenience, the following conventions are used in the following discussion of method 200. A short position refers to a short position in a single commodity contract. A single entity may hold multiple short positions, i.e., a holder of one short position may also hold one or more additional short positions in additional commodity contracts of the same type. Similarly, a long position refers to a long position in a single commodity contract. A single entity may hold multiple long positions. When describing method 200, “commodity contract,” “commodity contracts” and the like refer to contracts of the type for which an instance of method 200 is being performed.

In step 201, module 142 receives source data for short positions in commodity contracts. The source data received in step 201 indicates, for each of multiple short positions, a corresponding source location. Each source location represents a location from which the holder of the corresponding short position intends to make (or desires to make) delivery. In some cases, a commodity contract type may require a short to choose from a small number of predefined source locations. In other cases, a commodity contract type may allow substantially greater freedom to choose source location (e.g., any port able to accommodate a ship over a certain gross tonnage).

In some embodiments, module 142 receives source data in step 142 in response to inquiries (not shown) transmitted by system 100. For example, after trading has concluded in the commodity contracts, module 142 may receive data from other system 100 modules that identifies holders of short positions. Module 142 could then cause an email or other communication to be sent to the holder of each short position, which email could instruct the short position holder to confirm that delivery will be made and to specify the source location from which that delivery will be made. In other embodiments, a contract type may allow a short position holder to provide such confirmation and source specification any time after executing the contract. Other embodiments may include combinations of these features, e.g., short position holders may provide notice of intent to make delivery and source specification any time after execution, but module 142 may send an email requesting notice and source specification if the short position holder has not provided that information by a predefined time.

In step 203, module 142 receives destination data for long positions in commodity contracts. The destination data received in step 203 indicates, for each of multiple long positions, a corresponding destination location. Each destination location represents a location at which the holder of the corresponding long position intends to take (or desires to take) delivery. In some cases, a commodity contract type may require a long to choose from a small number of predefined destination locations. In other cases, a commodity contract type may allow substantially greater freedom to choose destination location. Module 142 may receive destination data in step 203 in a manner similar to that described for step 201 (e.g., in response to inquiries from module 142, in accordance with a contract allowing a long position holder to provide notice and destination specification after execution and before a defined time, etc.).

Although steps 201 and 203 are shown separately in FIG. 2A for convenience, the operations of steps 201 and 203 may occur simultaneously. Moreover, steps 201 and 203 need not occur in the order shown.

In step 205, module 142 determines if it has received source data for all outstanding short positions by a predefined time (e.g., by close of trading in the commodity contracts, by some predefined time after close of trading, etc.). If so, module 142 continues on the “yes” branch to step 209 (described below). If not, module 142 continues on the “no” branch to step 207. In step 207, module 142 identifies all of the short positions for which there is no source data. For each of those short positions, module 142 assigns a corresponding source location to the short position. The manner in which module 142 performs such assignment may be defined in the commodity contracts. For example, the commodity contracts may permit assignment of a default source location, or a random selection from one of several predefined source locations, if a short position holder fails to designate a source location. As another example, the commodity contracts may allow assignment of a source location designated by the same party in connection with another short position. From step 207, module 142 proceeds to step 209.

In step 209, module 142 determines if it has received destination data for all outstanding long positions by a predefined time (e.g., the same predefined time used in step 207). If so, module 142 continues on the “yes” branch to step 213 (described below). If not, module 142 continues on the “no” branch top step 211. In step 211, module 142 identifies all of the long positions for which there is no destination data. For each of those long positions, module 142 assigns a corresponding destination location to the long position. The manner in which module 142 makes such assignments, which may be defined by the commodity contracts, may be similar to that used in step 207 (e.g., assign predefined default destination, randomly choose and assign one of several predefined default destinations, etc.). From step 211, module 142 proceeds to step 213.

Although steps 205 and 207 are shown separately from steps 209 and 211 in FIG. 2A, this is also for convenience. Operations indicated by steps 205 and 207 may occur simultaneously with (or after) operations indicated by steps 209 and 211.

In step 213, module 142 determines the number of short positions that correspond to each of m source locations, where m is the total number of source locations. The m source locations and number of short positions corresponding to each of those source locations is determined based on data received in step 201 and, if step 207 was performed, on source location assignments made as part of step 207. The first two columns of Table 1 show data determined in step 213 in the current example.

TABLE 1

| source | | | |
|---|---|---|---|
| location | short | destination | long |
| (m = 4) | positions | location | positions |
| S1 | 1100 | | |
| S2 | 300 | | |
| S3 | 900 | | |
| S4 | 700 | | |
| Total | 3000 | | |

In the current example, the total number of source locations is four (m=4). This value of m is merely for purposes of illustration and is not limiting. There may be fewer or more source locations (i.e., m could be greater than or less than 4). Although the source locations in the example are identified generically as S1 through S4, it is to be appreciated that each represents a different physical geographic location. In the current example, there are 1100 short positions corresponding to source location S1, 300 short positions corresponding to source location S2, 900 short positions corresponding to source location S3 and 700 short positions corresponding to source location S4, for a total of 3000 outstanding short positions. These short position numbers are also merely for purposes of illustration and are not limiting.

In step 215, module 142 determines the number of long positions that correspond to each of n destination locations, where n is the total number of destination locations. The n destination locations and number of long positions corresponding to each of those destination locations is determined based on data received in step 203 and, if step 211 was performed, on destination location assignments made as part of step 211. Table 2 shows, in the third and fourth columns, data determined in step 215 in the current example. For convenience, Table 2 also includes the data determined in step 213.

TABLE 2

| source | | destination | |
|---|---|---|---|
| location | short | location | long |
| (m = 4) | positions | (n = 5) | positions |
| S1 | 1100 | D1 | 500 |
| S2 | 300 | D2 | 400 |
| S3 | 900 | D3 | 600 |
| S4 | 700 | D4 | 800 |
| | | D5 | 700 |
| Total | 3000 | | 3000 |

In the current example, the total number of destination locations is five (n=5). As with the number of source locations (m), the number of destination locations (n) shown by Table 2 is merely for purposes of illustration. Although the destination locations in the example are identified generically as D1 through D5, it is to be appreciated that each represents a different physical geographic location. In the current example, there are 500 long positions corresponding to destination location D1, 400 long positions corresponding to destination location D2, 600 long positions corresponding to destination location D3, 800 long positions corresponding to destination location D4 and 700 long positions corresponding to destination location D5. The total outstanding long positions is the same as the total outstanding short positions (3000 in the current example). As shown in Table 2, m≠n in the current example. This may not always be the case, however, m and n might be equal in some situations.

From step 215, module 142 proceeds to step 217 (FIG. 2B). In step 217, module 142 accesses delivery cost data. The delivery cost data includes values for each source-destination pair. Each source-destination pair is a different combination of one of the m source locations and one of the n destination locations. For each such combination, the delivery cost data value represents the cost to transport a predefined quantity of the commodity at issue (i.e., the commodity each of the short position holders is obligated to deliver and each of the long position holders is obligated to receive) from the source location of the pair to the destination location of the pair. The predefined quantity may be, e.g., the quantity specified by one commodity contract. Depending on the commodity, the delivery cost may represent a cost to transport by ship or barge, a cost to transport by rail, a cost to transport by truck, a cost to transport by multiple methods, a cost to transport and to store for a certain amount of time, etc. Table 3 shows the delivery cost data received by module 142 at step 217 in the current example.

TABLE 3

| | D1 | D2 | D3 | D4 | D5 |
|---|---|---|---|---|---|
| S1 | $75.25 | $83.50 | $74.50 | $78.25 | $73.50 |
| S2 | $76.50 | $78.75 | $79.00 | $75.50 | $80.25 |
| S3 | $76.75 | $79.25 | $77.00 | $78.75 | $77.25 |
| S4 | $79.00 | $78.78 | $76.25 | $81.50 | $83.25 |

In Table 3, each numerical value in a cell is a delivery cost data value for the source-destination pair indicated by the row and column of the cell. For example, the delivery cost data value for the source-destination pair S3−D2 ($79.25) represents a cost to deliver a predefined quantity of the commodity at issue from source location S3 to destination location D2. As with values in Tables 1 and 2, the delivery cost data values in Table 3 are merely for purposes of illustration.

The delivery cost data accessed in step 217 may be pre-stored in module 142 or in a database accessible by module 142. In some embodiments, step 217 may include retrieving and/or updating delivery cost data from one or more sources external to system 100.

In step 219, module 142 identifies constraints to be applied when allocating delivery obligations. For example, in some embodiments the allocation is performed so that each short position is allocated to a source-destination pair that includes the source location corresponding to that short position (as indicated in step 201 or assigned in step 207) and so that each long position is allocated to a source-destination pair that includes the destination location corresponding to that long position (as indicated in step 203 or assigned in step 211). In the current example, these constraints can be summarized as shown in Table 4.

TABLE 4
N(S1:D1) + N(S2:D1) + N(S3:D1) + N(S4:D1) = 500
N(S1:D2) + N(S2:D2) + N(S3:D2) + N(S4:D2) = 400
N(S1:D3) + N(S2:D3) + N(S3:D3) + N(S4:D3) = 600
N(S1:D4) + N(S2:D4) + N(S3:D4) + N(S4:D4) = 800
N(S1:D5) + N(S2:D5) + N(S3:D5) + N(S4:D5) = 700
N(S1:D1) + N(S1:D2) + N(S1:D3) + N(S1:D4) + N(S1:D5) = 1100
N(S2:D1) + N(S2:D2) + N(S2:D3) + N(S2:D4) + N(S2:D5) = 300
N(S3:D1) + N(S3:D2) + N(S3:D3) + N(S3:D4) + N(S3:D5) = 900
N(S4:D1) + N(S4:D2) + N(S4:D3) + N(S4:D4) + N(S4:D5) = 700

In the constraints of Table 4, “N(S______:D______)” indicates the number of short positions (as well as the number of long positions) allocated to the source-destination pair that includes source “S______” and destination “D______”. Each N(S______:D______) value is a positive integer or zero. Examples of other possible constraints are described below.

In step 221, module 142 allocates delivery obligations of the short and long positions among one or more of the source-destination pairs. Module 142 allocates short and long positions to source-destination pairs so as to minimize a total delivery cost while satisfying all constraints identified in step 219. In some embodiments, module 142 performs the allocation of step 221 using linear programming. Linear programming is an iterative technique by which an objective function is optimized according to predefined constraints. Linear programming, as well as linear programming solutions to other transport cost minimization problems, are well known in the art. For example, the EXCEL spread sheet program sold by Microsoft Corporation (of Redmond Wash., US) includes a “SOLVER” component that performs linear programming according to user-defined constraints.

In the current example, the objective function is set forth below

Example Objective Function:

$$TC = {\sum }_{j = 1}^{n} {\sum }_{i = 1}^{m} N ( Si \text{:} Dj ) * C ( Si \text{:} Dj )$$

where
   “TC” is the total cost to be minimized,
   “N(Si:Dj)” indicates the number of short positions (as well as the number of long positions) allocated to the source-destination pair that includes source Si and destination Dj, and
   “C(Si:Dj)” is the transport cost value associated with the source-destination pair that includes source Si and destination Dj (e.g., C(S1:D1) in Table 3 is $75.25).

The objective function in the current example can also be written in expanded form:

$$TC = N ( S 1 \text{:} D 1 ) * C ( S 1 \text{:} D 1 ) + N ( S 2 \text{:} D 1 ) * C ( S 2 \text{:} D 1 ) + N ( S 3 \text{:} D 1 ) * C ( S 3 : D 1 ) + N ( S 4 \text{:} D 1 ) * C ( S 4 \text{:} D 1 ) + N ( S 1 \text{:} D 2 ) * C ( S 1 \text{:} D 2 ) + N ( S 2 \text{:} D 2 ) * C ( S 2 \text{:} D 2 ) + N ( S 3 \text{:} D 2 ) * C ( S 3 \text{:} D 2 ) + N ( S 4 \text{:} D 2 ) * C ( S 4 \text{:} D 2 ) + N ( S 1 \text{:} D 3 ) * C ( S 1 \text{:} D 3 ) + N ( S 2 \text{:} D 3 ) * C ( S 2 \text{:} D 3 ) + N ( S 3 \text{:} D 3 ) * C ( S 3 \text{:} D 3 ) + N ( S 4 \text{:} D 3 ) * C ( S 4 \text{:} D 3 ) + N ( S 1 \text{:} D 4 ) * C ( S 1 \text{:} D 4 ) + N ( S 2 \text{:} D 4 ) * C ( S 2 \text{:} D 4 ) + N ( S 3 \text{:} D 4 ) * C ( S 3 \text{:} D 4 ) + N ( S 4 \text{:} D 4 ) * C ( S 4 \text{:} D 4 ) + N ( S 1 \text{:} D 5 ) * C ( S 1 \text{:} D 5 ) + N ( S 2 \text{:} D 5 ) * C ( S 2 \text{:} D 5 ) + N ( S 3 \text{:} D 5 ) * C ( S 3 \text{:} D 5 ) + N ( S 4 \text{:} D 5 ) * C ( S 4 \text{:} D 5 )$$

Table 5 shows the allocation performed by module 142 in the current example by optimizing (i.e., minimizing) TC based on the data in Tables 2 and 3 and based on the constraints in Table 4.

TABLE 5

| | D1 | D2 | D3 | D4 | D5 | Total |
|---|---|---|---|---|---|---|
| S1 | 100 | 0 | 300 | 0 | 700 | 1100 |
| S2 | 0 | 0 | 0 | 300 | 0 | 300 |
| S3 | 400 | 0 | 0 | 500 | 0 | 900 |
| S4 | 0 | 400 | 300 | 0 | 0 | 700 |
| Total | 500 | 400 | 600 | 800 | 700 | |

The total cost (TC) resulting from the above allocation, using the delivery cost value of Table 3, is $228,437.

In step 223, and using the allocation of step 221, module 142 generates assignments of long positions and short positions. In particular, module 142 assigns each of the outstanding long positions to a different one of the outstanding short positions (and thus, assigns each of the outstanding short positions to a different one of the outstanding long positions) until there is a one-to-one mapping of short positions to long positions that fulfills the allocation of step 221. For example, module 143 assigns each of 100 of the outstanding long positions corresponding to destination location D1 to one of 100 of the short positions corresponding to source location S1, assigns each of the remaining 400 D1 long positions to one of 400 of the S3 short positions, assigns each of the 400 D2 long positions to one of 400 of the S4 short positions, etc. In some embodiments, module 140 randomly selects short and long positions during these assignments. For example, module 142 may randomly select one of the D1 long positions and assign it to a randomly-selected one of the S1 short positions, randomly select one of the unassigned D1 long positions and assign it to a randomly-selected one of the unassigned S1 short positions, etc. In some embodiments, module 142 may generate the assignments in step 223 based on oldest outstanding positions. For example, module 142 may select the oldest D1 long position and assign it to the oldest S1 short positions, select the next oldest D1 long position and assign it to the next oldest S1 short position, etc. Other methods and/or combinations of methods can be used to generate the assignments in step 223.

In step 225, module 142 transmits notifications to the holders of the short and long positions indicating the assignments generated in step 223. Such transmission could include, e.g., automatically generating and sending emails to the holders of each short position and to the holders of each long position. An email to a holder of a short position may identify a destination location where the commodity is be delivered and a long position holder that will take delivery. An email to a holder of a long position may identify the short position holder that will make delivery.

As indicated above, in some embodiments there may be additional constraints identified in step 219 and applied when allocating short and long positions to source-destination pairs in step 221. For example, instead of the example values in Tables 2 and 3, assume long and short positions corresponding to S1−S4 and D1−D5 as shown below in Table 6 and delivery cost data as shown below in Table 7.

TABLE 6

| source | | destination | |
|---|---|---|---|
| location | short | location | long |
| (m = 4) | positions | (n = 5) | positions |
| S1 | 750 | D1 | 200 |
| S2 | 750 | D2 | 200 |
| S3 | 750 | D3 | 200 |
| S4 | 750 | D4 | 2200 |
| | | D5 | 200 |
| Total | 3000 | | 3000 |

TABLE 7

| | D1 | D2 | D3 | D4 | D5 |
|---|---|---|---|---|---|
| S1 | $72.00 | $74.00 | $73.25 | $77.00 | $74.50 |
| S2 | $76.50 | $75.50 | $74.75 | $81.25 | $73.50 |
| S3 | $75.25 | $75.00 | $72.75 | $74.50 | $78.50 |
| S4 | $77.00 | $76.00 | $75.00 | $74.00 | $77.00 |

Note that C(S2:D4), the value for delivery cost associated with deliveries from source location S2 to destination location D4, is higher than other cost values in Table 7. Using the data from Tables 6 and 7 and applying only the constraints of Table 4 results in a total delivery cost (TC) of $225,062.50 and a delivery allocation as shown in Table 8.

TABLE 8

| | D1 | D2 | D3 | D4 | D5 | Total |
|---|---|---|---|---|---|---|
| S1 | 200 | 0 | 0 | 550 | 0 | 750 |
| S2 | 0 | 200 | 200 | 150 | 200 | 750 |
| S3 | 0 | 0 | 0 | 750 | 0 | 750 |
| S4 | 0 | 0 | 0 | 750 | 0 | 750 |
| Total | 100 | 100 | 100 | 2500 | 200 | |

With the allocation of Table 8, however, the delivery costs for the 150 short positions and 150 long positions allocated to S2:D4 will be noticeably higher than delivery costs associated with other source-destination pairs. To avoid this, an additional constraint could be added to the constraints of Table 4. Table 9 shows the constraints of Table 4 with the added constraint at the bottom.

TABLE 9

N(S1:D1) + N(S2:D1) + N(S3:D1) + N(S4:D1) = 500
N(S1:D2) + N(S2:D2) + N(S3:D2) + N(S4:D2) = 400
N(S1:D3) + N(S2:D3) + N(S3:D3) + N(S4:D3) = 600
N(S1:D4) + N(S2:D4) + N(S3:D4) + N(S4:D4) = 800
N(S1:D5) + N(S2:D5) + N(S3:D5) + N(S4:D5) = 700
N(S1:D1) + N(S1:D2) + N(S1:D3) + N(S1:D4) + N(S1:D5) = 1100
N(S2:D1) + N(S2:D2) + N(S2:D3) + N(S2:D4) + N(S2:D5) = 300
N(S3:D1) + N(S3:D2) + N(S3:D3) + N(S3:D4) + N(S3:D5) = 900
N(S4:D1) + N(S4:D2) + N(S4:D3) + N(S4:D4) + N(S4:D5) = 700
N(S2:D4) = 0

Table 10 shows the allocation that results using the data of Tables 6 and 7 and the constraints of Table 9.

TABLE 10

| | D1 | D2 | D3 | D4 | D5 | Total |
|---|---|---|---|---|---|---|
| S1 | 50 | 0 | 0 | 700 | 0 | 750 |
| S2 | 150 | 200 | 200 | 0 | 200 | 750 |
| S3 | 0 | 0 | 0 | 750 | 0 | 750 |
| S4 | 0 | 0 | 0 | 750 | 0 | 750 |
| Total | 100 | 100 | 100 | 2500 | 200 | |

The total delivery cost TC associated with the allocation of Table 10 is $225,100. This is only slightly higher than the total delivery cost TC associated with the allocation of Table 8, but avoids any deliveries at the highest delivery cost.

Thus, in some embodiments a constraint may be added to prevent allocation to source-destination pairs associated with a delivery cost that is above a certain threshold. That threshold could be a fixed value or could be set in other ways (e.g., a predefined percentage of the next highest delivery cost value).

Numerous other constraints could be employed. For example, there may be a limit on the number of deliveries that can be made from a specific source location to a specific destination location. In such a circumstance, a constraint in the form N(Sy:Dz)≦L could be added, where “N(Sy:Dz)” is the number of short and long positions allocated to the Sy:Dz source destination pair (with y being one 1 through in and z being one of 1 through n), and where “L” is the maximum number of short and long positions that can be allocated (with L being less than the total number of short positions corresponding to source location Sy).

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that some steps illustrated in the figures may be performed in other than the recited order, and that one or more steps illustrated may be optional in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
determining, by a computer system and for each of m source locations, a number of commodity contract short positions for which delivery of a commodity will originate from that source location, wherein each of the short positions corresponds to an obligation of the short position holder to make delivery of the commodity within a predefined time period;
determining, by the computer system and for each of n destination locations, a number of commodity contract long positions for which delivery of the commodity will be made at that destination location, wherein each of the long positions corresponds to an obligation of the long position holder to receive delivery of the commodity within the predefined time period;
accessing, by the computer system, delivery cost data for each of multiple source-destination pairs, wherein each of the source-destination pairs represents a different combination of one of the m source locations and one of the n destination locations;
identifying a first allocation constraint by the computer system, by:
determining that a delivery cost data value for an identified one of multiple source-destination pairs exceeds a threshold, and
based on the determination that the threshold is exceeded, excluding the identified source-destination pair from allocation of short and long positions;
allocating the short and long positions among each of one or more of the source-destination pairs not excluded, wherein the allocation is performed by the computer system based at least in part on the delivery cost data, and wherein the allocation minimizes a total delivery cost and satisfies the identified allocation constraints;
generating, by the computer system, assignments of the long positions and the short positions fulfilling the allocation; and
transmitting, by the computer system, notifications to holders of the short and long positions indicating the assignments.

2. The method of claim 1, further comprising:
receiving, at the computer system and for each of the short positions, data indicating one of the m source locations corresponding to that short position; and
receiving, at the computer system and for each of the long positions, data indicating one of the n destination locations corresponding to that long position.

3. The method of claim 1, wherein the threshold is a predefined percentage of a next highest delivery cost value.

4. The method of claim 1, further comprising identifying a second allocation constraint by
determining a numerical limit for a number of deliveries from one of the source locations to one of the destination locations, and
based on the determination of the numerical limit, implementing a constraint on the maximum number of short positions and long positions to be allocated to the source-destination pair representing the one of the source locations and the one of the destination locations.

5. The method of claim 1, wherein the short positions and the long positions are positions in commodity futures contracts.

6. The method of claim 1, further comprising:
receiving, at the computer system and for each of less than all of the short positions, data indicating one of the m source locations corresponding to that short position; and
assigning, by the computer system, after determining that a time for holders of short positions to indicate a source location has expired, and for each of the short positions for which data indicating a source location was not received, one of the m source locations as a source location corresponding to that short position.

7. The method of claim 1, further comprising
receiving, at the computer system and for each of less than all of the long positions, data indicating one of the n destination locations corresponding to that long position; and
assigning, by the computer system, after determining that a time for holders of long positions to indicate a destination location has expired, and for each of the long positions for which data indicating a destination location was not received, one of the n destination locations as a destination location corresponding to that long position.

8. One or more non-transitory computer-readable media storing computer executable instructions that, when executed, cause a computer system to perform operations that include:
determining, for each of m source locations, a number of commodity contract short positions for which delivery of a commodity will originate from that source location, wherein each of the short positions corresponds to an obligation of the short position holder to make delivery of the commodity within a predefined time period;
determining, for each of n destination locations, a number of commodity contract long positions for which delivery of the commodity will be made at that destination location, wherein each of the long positions corresponds to an obligation of the long position holder to receive delivery of the commodity within the predefined time period;
accessing delivery cost data for each of multiple source-destination pairs, wherein each of the source-destination pairs represents a different combination of one of the m source locations and one of the n destination locations;
identifying a first allocation constraint by:
determining that a delivery cost data value for an identified one of multiple source-destination pairs exceeds a threshold, and
based on the determination that the threshold is exceeded, excluding the identified source-destination pair from allocation of short and long positions;
allocating the short and long positions among each of one or more of the source-destination pairs not excluded, wherein the allocation is based at least in part on the delivery cost data, and wherein the allocation minimizes a total delivery cost and satisfies the identified allocation constraints;
generating assignments of the long positions and the short positions fulfilling the allocation; and
transmitting notifications to holders of the short and long positions indicating the assignments.

9. The one or more non-transitory computer-readable media of claim 8, wherein the stored instructions further comprise instructions that, when executed, cause the computer system to perform operations that include:
receiving, for each of the short positions, data indicating one of the m source locations corresponding to that short position; and
receiving, for each of the long positions, data indicating one of the n destination locations corresponding to that long position.

10. The one or more non-transitory computer-readable media of claim 8, wherein the threshold is a predefined percentage of a next highest delivery cost value.

11. The one or more non-transitory computer-readable media of claim 8, wherein the stored instructions further comprise instructions that, when executed, cause the computer system to perform operations that include identifying a second allocation constraint by
determining a numerical limit for a number of deliveries from one of the source locations to one of the destination locations, and
based on the determination of the numerical limit, implementing a constraint on the maximum number of short positions and long positions to be allocated to the source-destination pair representing the one of the source locations and the one of the destination locations.

12. The one or more non-transitory computer-readable media of claim 8, wherein the short positions and the long positions are positions in commodity futures contracts.

13. The one or more non-transitory computer-readable media of claim 8, wherein the stored instructions further comprise instructions that, when executed, cause the computer system to perform operations that include:
receiving, for each of less than all of the short positions, data indicating one of the m source locations corresponding to that short position; and
assigning, after determining that a time for holders of short positions to indicate a source location has expired, and for each of the short positions for which data indicating a source location was not received, one of the m source locations as a source location corresponding to that short position.

14. The one or more non-transitory computer-readable media of claim 8, wherein the stored instructions further comprise instructions that, when executed, cause the computer system to perform operations that include:
receiving, for each of less than all of the long positions, data indicating one of the n destination locations corresponding to that long position; and
assigning, after determining that a time for holders of long positions to indicate a destination location has expired, and for each of the long positions for which data indicating a destination location was not received, one of the n destination locations as a destination location corresponding to that long position.

15. A computer system comprising:
at least one processor; and
at least one non-transitory memory, wherein the at least one non-transitory memory stores instructions that, when executed, cause the computer system to perform operations that include
determining, for each of m source locations, a number of commodity contract short positions for which delivery of a commodity will originate from that source location, wherein each of the short positions corresponds to an obligation of the short position holder to make delivery of the commodity within a predefined time period,
determining, for each of n destination locations, a number of commodity contract long positions for which delivery of the commodity will be made at that destination location, wherein each of the long positions corresponds to an obligation of the long position holder to receive delivery of the commodity within the predefined time period,
accessing delivery cost data for each of multiple source-destination pairs, wherein each of the source-destination pairs represents a different combination of one of the m source locations and one of the n destination locations,
identifying a first allocation constraint by:
determining that a delivery cost data value for an identified one of multiple source-destination pairs exceeds a threshold, and
based on the determination that the threshold is exceeded, excluding the identified source-destination pair from allocation of short and long positions,
allocating the short and long positions among each of one or more of the source-destination pairs not excluded, wherein the allocation is based at least in part on the delivery cost data, and wherein the allocation minimizes a total delivery cost and satisfies the identified allocation constraints,
generating assignments of the long positions and the short positions fulfilling the allocation, and
transmitting notifications to holders of the short and long positions indicating the assignments.

16. The computer system of claim 15, wherein the stored instructions further comprise instructions that, when executed, cause the computer system to perform operations that include
receiving, for each of the short positions, data indicating one of the m source locations corresponding to that short position, and
receiving, for each of the long positions, data indicating one of the n destination locations corresponding to that long position.

17. The computer system of claim 15, wherein the threshold is a predefined percentage of a next highest delivery cost value.

18. The computer system of claim 15, wherein the stored instructions further comprise instructions that, when executed, cause the computer system to perform operations that include identifying a second allocation constraint by
determining a numerical limit for a number of deliveries from one of the source locations to one of the destination locations, and
based on the determination of the numerical limit, implementing a constraint on the maximum number of short positions and long positions to be allocated to the source-destination pair representing the one of the source locations and the one of the destination locations.

19. The computer system of claim 15, wherein the short positions and the long positions are positions in commodity futures contracts.

20. The computer system of claim 15, wherein the stored instructions further comprise instructions that, when executed, cause the computer system to perform operations that include
receiving, for each of less than all of the short positions, data indicating one of the m source locations corresponding to that short position, and
assigning, after determining that a time for holders of short positions to indicate a source location has expired, and for each of the short positions for which data indicating a source location was not received, one of the m source locations as a source location corresponding to that short position.

21. The computer system of claim 15, wherein the stored instructions further comprise instructions that, when executed, cause the computer system to perform operations that include
receiving, for each of less than all of the long positions, data indicating one of the n destination locations corresponding to that long position, and
assigning, after determining that a time for holders of long positions to indicate a destination location has expired, and for each of the long positions for which data indicating a destination location was not received, one of the n destination locations as a destination location corresponding to that long position.
